(19) United States
(12) Patent Application Publication
(10) Pub. No.: US 2007/0038764 A1
(43) Pub. Date: Feb. 15, 2007

(54) Network equipment for supplying multimode mobile terminals with data necessary for automatically selecting radio access network interfaces during service sessions

(75) Inventor: Herve Maillard, Igny (FR)

Correspondence Address: SUGHRUE MION, PLLC, 2100 PENNSYLVANIA AVENUE, N.W., SUITE 800, WASHINGTON, DC, 20037, US

(73) Assignee: ALCATEL

(21) Appl. No.: 11/447,209

(22) Filed: Jun. 6, 2006

(30) Foreign Application Priority Data
Jun. 7, 2005 (FR) 0551524

(51) Int. Cl. G06F 15/16

(52) U.S. Cl. 709/229

(57) ABSTRACT

A network equipment is dedicated to radio access networks of different types connected to a backbone network to which is coupled at least one application equipment including at least one external application adapted to exchange data with at least one internal application installed on multimode mobile terminals and further comprising at least two network interfaces adapted to be connected to radio access networks. The equipment comprises management means adapted to transmit to a designated terminal a control software module adapted once installed to provide a proxy interface function between internal and external applications adapted each time that it receives a transaction request designating an external application from an internal application of the terminal to determine which of the network interfaces of the terminal is suited to the transaction as a function of control information and routing information and then to instruct the operating system of the terminal to transmit the transaction request to the designated external application via a transport level connection between the determined network interface and the application equipment containing the external application.

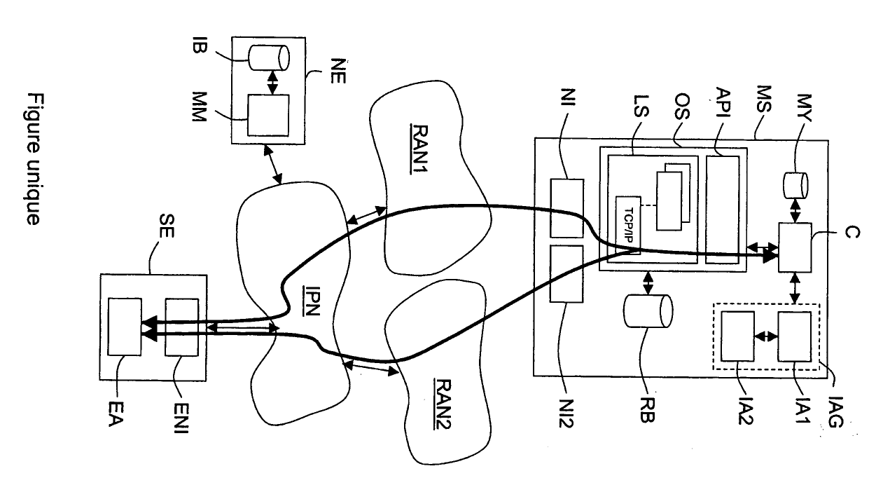

### CROSS-REFERENCE TO RELATED APPLICATIONS

This application is based on French Patent Application No. 0551524 filed Jul. 6, 2005, the disclosure of which is hereby incorporated by reference thereto in its entirety, and the priority of which is hereby claimed under 35 U.S.C. §119.

### BACKGROUND OF THE INVENTION

1. Field of the Invention

The invention relates to groups of radiocommunication networks coupled to each other via a backbone network and more precisely to controlling the access of mobile terminals to radio access networks for communicating with external applications during service sessions.

2. Description of the Prior Art

In the present context, the expression “mobile terminal” refers to any mobile or portable radiocommunication terminal capable of exchanging data in the form of radio signals either with another terminal or network equipment via their parent network(s) or with its own parent network, for example mobile telephones and portable (laptop) computers or personal digital assistants (PDA) equipped with radiocommunication modules.

Some mobile terminals, known as multimode terminals, are adapted to access a plurality of (at least two) different radio access networks, for example, on the one hand, GPRS/EDGE and/or UMTS communication networks and, on the other hand, WLAN and/or WiFi and/or WiMAX communication networks. These terminals therefore have a plurality of network interfaces defined on telephone (GPRS/EDGE or UMTS) or PCMCIA (WiFi or WiMAX) electronic communication cards, for example, enabling them to connect to the corresponding radio access networks. It is also possible to constitute a “multimode” terminal by combining two mobile terminals, for example a mobile telephone connected via a serial port to a portable (laptop) computer.

For example, if the backbone network to which the radio access networks are coupled is an Internet Protocol (IP) network, the multimode terminals can connect via the radio access networks to network (or application) equipments coupled to the Internet Protocol network and including external application servers (or Internet sites) in order to exchange data with those servers. For example, an external application may be dedicated to transmitting music or video (“streaming” mode transmission of audio, video and like data streams).

For the user of a multimode terminal to be able to download data managed by a remote external application, his terminal must have an internal application, for example a web browser, capable of initiating a service session with said external application.

As the person skilled in the art is aware, a service session is made up of (service) transactions of different types defined by specific characteristics and associated with service semantics. The service semantic defines the sense of a given transaction given the application concerned. For example, a transaction may consist in looking for an Internet site or a given page of an Internet site, requesting the transmission of a film, or requesting the temporary or permanent stopping of a film.

Each transaction emanating from an (internal or external) requesting application must be transmitted to the requested (external or internal) application that it designates via a transport (socket) level connection set up between the equipments (for example a multimode terminal and an application server) in which the requesting and requested applications (internal and external) are installed.

Successive transactions of the same type or of different types during the same session do not necessarily require to use the same high bit rate or even very high bit rate (transport level) connection. For example, it is of no utility to use a very high bit rate connection to transmit a request for temporary or permanent stopping of the transmission of video data, whereas video data transmission itself necessitates a very high bit rate connection.

Likewise, under certain circumstances, it would be desirable to wait briefly for access to a high bit rate connection to be possible, rather than to initiate immediately a session using a lower bit rate connection leading to a lower quality of reproduction. For example, if a UMTS/WiFi bimode terminal were to be moved in an area in which there are WiFi hot spots, it would be advantageous to wait in order to transmit high bit rate video data to it via the WiFi access network each time that it reaches a hot spot.

It follows from the above analysis that it would be particularly advantageous to be able to choose a radio access network suited to each transaction that a multimode terminal requires to perform. This is not possible at present.

Multimode terminals such as portable (laptop) computers and PDAs are at present adapted to select the network interface to be used to access a requested application as a function of the destination address of the application equipment in which the requested application is installed and the route (or path) that is in particular associated with that destination address in the routing table of the multimode terminal.

Consequently, if a route of this kind exists in the routing table, the requesting application is obliged to select the network interface that is connected to the radio access network through which that route passes. If no such route exists in the routing table, the requesting application is obliged to use a default route that is linked to a network interface providing connectivity to a single radio access network. Thus in practice the network interface linked to the default route is systematically used unless it is not available.

In current multimode terminals, the requesting (internal) application therefore has no control over the network interfaces that are used to perform transactions.

In an attempt to improve on this situation, Alcatel has proposed modifying the operating system of the multimode terminals in order to enrich the API socket (transport level connection application programming interface) layer and to modify the internal applications in order for them to be able to use access network selection mechanisms capable of using the modifications made to the API socket layer. This solution obliges the manufacturers of multimode terminal internal applications to modify them and does not enable radio access network operators to have any input with respect to the mode of selecting their access networks, which significantly restricts the selection criteria.

An object of the invention is to improve on this situation.

### SUMMARY OF THE INVENTION

To this end the invention proposes a network equipment for a group comprising at least two radio access networks of different types connected to a backbone network to which is coupled at least one application equipment including at least one external application adapted to exchange data with at least one internal application installed on multimode radiocommunication mobile terminals and each further comprising an operating system, at least two network interfaces coupled to the operating system and each having an address and being adapted to be connected to respective radio access networks of the group, which network equipment comprises management means adapted to transmit to a designated multimode mobile terminal via a signaling connection a control software module adapted once installed on the designated terminal to provide a proxy interface function between its internal applications and external applications and adapted each time that it receives a transaction request designating an external application from an internal application of the terminal to determine which of the network interfaces of the terminal is suited to the transaction as a function of control information and routing information and then to instruct the operating system to transmit the transaction request to the designated external application via a transport level connection between the determined network interface and the application equipment containing the external application.

In the present context, the expression “proxy function” refers to a module interleaved between two applications and passing itself off as one of the two applications to the other application, and vice-versa, in accordance with the IETF definition.

The network equipment of the invention may have other features, and in particular, separately or in combination:

it may comprise memory means adapted to store at least some of the control information, in which case its management means are adapted to transmit to the mobile terminals via the signaling connection control information that concerns them stored in the memory means so that their control software module can use the information to determine a network interface to be used to transmit at least one transaction request;

its management means may be adapted on receiving a request from a control software module of a mobile terminal to transmit control information that concerns it to the control software module via the signaling connection set up with its mobile terminal;

its management means may instead be adapted on receiving instructions from a radio access network designating at least one mobile terminal to transmit control information that concerns it to the control software module of that designated terminal via the signaling connection;

its management means may be adapted to initiate the setting up of a signaling connection with a designated terminal;

the control information is selected, for example, from data on application types associated with data on network interface types, data on transaction types associated with data on network interface types, data on application types and transaction types associated with data on network interface types, data representing the weight of the data to be transmitted to an internal application and associated with data on network interface types, and network information data associated with data on network interface types;

its processing means may be adapted to communicate with each software module installed in a mobile terminal using a HyperText Transmission Protocol.

### BRIEF DESCRIPTION OF THE DRAWING

Other features and advantages of the invention will become apparent on reading the following detailed description and examining the appended drawing, the single FIGURE of which is a diagram of one embodiment of a network equipment of the invention coupled to a backbone network to which are connected two radio access networks themselves coupled to a bimode mobile terminal. The appended drawing constitutes part of the description of the invention as well as contributing to the definition of the invention, if necessary.

### DETAILED DESCRIPTION OF THE PREFERRED EMBODIMENT

An object of the invention is to offer multimode radiocommunication mobile terminals the possibility of selecting radio access networks automatically during service sessions.

The multimode radiocommunication mobile terminals considered hereinafter by way of nonlimiting example are bimode portable computers equipped with a WiFi PCMCIA card and a UMTS mobile telephone card. However, the invention is not limited to this application alone, of course. It relates to all mobile or portable multimode communication terminals capable of exchange data in the form of radio signals either with another terminal or network equipment via their parent network(s) or with its own parent network, for example multimode mobile telephones or personal digital assistants (PDA). Moreover, the invention is not limited to UMTS/WiFi bimode terminals. It relates to all mobile terminals capable of accessing at least two radio access networks of different types using at least two network interfaces corresponding to said different types and each having its own address. Thus the invention relates in particular to the following network interface combinations: GSM and/or GPRS/EDGE and/or UMTS (or HSDPA) and/or WLAN (wireless local area network, for example a Hyperlan network (according to the ETSI standard) or an 802.11 network (according to the IEEE standard)) and/or WMAN (wireless metropolitan area network, for example an 802.16 network according to the IEEE standard) and/or Bluetooth.

The single figure shows by way of example two radio access networks RAN1 and RAN2 connected to a backbone network IPN, for example an Internet Protocol (IP) network such as the Internet.

For example, the radio access network RAN1 is a UMTS network and the radio access network RAN2 is a WiFi network. Of course, the group of radio access networks may comprise than two radio access networks.

In this example, a remote application equipment SE coupled to the backbone network IPN contains at least one external application EA. This remote network equipment SE is an application server, for example, having an IP address, for example. The external application EA is an application dedicated to video streaming, for example.

As a general rule, a large number of application equipments SE are coupled to the backbone network IPN in this way.

In this example, multimode mobile terminals MS (for example portable computers) can be connected to the backbone network IPN via the radio access networks RAN1 and RAN2.

Each multimode mobile terminal MS comprises, in the conventional way:

an operating system OS, for example Windows or Linux, including in particular an application programming interface API and a layer stack LS including a transport layer, for example of the TCP/IP type,

a routing database RB which is coupled to the operating system OS and which stores routing data defining routes (or paths) providing access to remote equipments designated by addresses known as destination addresses, for example IP addresses, this database taking the form of a routing table; to be more precise, each entry in the routing table is a destination address,

a group IAG of at least one internal application IA1 enabling exchange of data with at least one external application EA implemented in a remote application equipment SE; for example, the internal application IA is a web browser coupled to another internal application IA2 dedicated to playback of videos, and

at least two network interfaces NI1 and NI2 coupled to the operating system OS and adapted to be connected to the radio access networks RAN1 and RAN2, respectively, and each having an IP address, for example.

According to the invention, at least some of the multimode terminals MS further comprise a control software module CM that is transmitted to them by a network equipment NE via a signaling connection (not shown).

To be more precise, according to the invention, the network equipment NE comprises a management module MM for transmitting the control software module CM to a designated multimode mobile terminal MS via a signaling connection.

This transmission (downloading) is effected either at the initiative of a multimode terminal MS or at the initiative of the network equipment NE when it receives an instruction to that effect, for example from the operator of the communication network(s) to which the user of a multimode terminal MS is a subscriber, for example if that user subscribes to an automatic radio access network selection option.

Each signaling connection that is set up between a multimode terminal MS and the network equipment NE and enables a control software module CM to be transmitted to it is initiated either by the management module MM of the network equipment NE when it takes the initiative for that transmission or by the multimode terminal MS when it requests that transmission.

The control software module CM can take the form of what the person skilled in the art calls a proxylet, for example.

The control software module CM is adapted, once installed in the designation multimode terminal MS, to provide a proxy interface function between the group IAG comprising its internal applications IA1 and IA2 and the external applications EA.

As indicated above, the definition of the proxy function is here the IETF definition. Consequently, it consists of a software (or electronic data processing) module intended to be interleaved (once installed) between internal applications (here applications IA1 and IA2) of a multimode terminal and external applications (here application EA) and passing itself off as one application to another application and vice-versa.

Once installed in a multimode terminal MS, each time that an internal application IA1 (here i=1 or 2) sends it a service transaction request designating an external application EA during a service session the control software module CM with the proxy function determines as a function of control information and routing information which of the network interfaces NIj (here j=1 or 2) is the one that is suited to the transaction.

In the present context, the expression “routing information” refers to routing data stored in the routing table of the routing database RB and to availability data indicating if the network interfaces NIj are connected to the corresponding radio access networks RANj or not.

For example, exchanges between an internal application IAi and the control software module CM may be effected in accordance with a transport protocol such as the UDP (User Datagram Protocol), TCP/IP (Transmission Control Protocol/Internet Protocol) or SCTP (Streaming Control Transport Protocol), among others.

According to version 4 of the Internet Protocol (IPv4), the control software module CM has an internal address (known to the person skilled in the art as a loopback address), such as the address 127.0.0.1. This internal address, which designates the port number of the control software module CM, is known to each internal application IAi of the group IAG. It is integrated into the header of the IP packets containing the transaction request to be transmitted, just like the destination address designating the network equipment SE containing the external application EA to which the requested transaction relates.

The control software module CM accesses the routing data by sending system commands to the operating system OS that is coupled to the routing database RB in which the routing table is stored. The control software module CM also accesses the availability data by sending system commands to the operating system OS, to be more precise to its API.

In the present context the expression “control information” refers to any data specifying a type of network interface NIj to be used in corresponding relationship to an internal application type and/or a transaction type and/or network information.

The transaction type designates not only one or more operations to be effected but also what the person skilled in the art refers to as the service semantic associated with the transaction. The designation of an operation to be effected may include information relating to the weight of a video file to be downloaded, for example.

The network information may consist of information data representing the costs of access to the various radio access networks RANj or of load balancing information data, for example.

The control information defines as it were a table that matches a given network interface NIj to a given situation defined by a designated internal application and/or a requested transaction and/or network information. Accordingly, each time that the control software module CM receives a transaction request to be transmitted to an external application EA, it determines the present situation (defined by the control information available to it) and selects the network interface NIj that corresponds to that situation and that the operating system OS must use to transmit the transaction request to the designated external application EA, provided that it is available.

The control information may be stored in a multimode terminal MS in memory means MY that can take any form, in particular the form of a memory or a database.

Some at least of the control information may be downloaded to a multimode terminal MS into which the control software module CM has been downloaded by a network equipment of the operator of the communication network(s) to which the user of the multimode terminal MS is a subscriber, for example. As shown in the single figure, it is advantageous (although not obligatory) if the network equipment NE that transmits the control information to the multimode terminals MS is also the one from which their control software module CM was downloaded. In this case, it is the management module MM of the network equipment NE that manages the transmission of control information via the signaling connections set up previously. For example, the management module MM is to this end coupled to memory means such as an information database IB installed in the network equipment NE and in which the control information is stored, where applicable in corresponding relationship to the identifiers of the multimode terminals MS (into which a control software module CM has been downloaded).

Control information can be downloaded at the initiative of the management module MM of the network equipment NE, for example periodically, each time that an event occurs in the network or when new internal or external applications come onto the market. However, downloading control information at the initiative of a control software module CM may equally be envisaged, for example periodically, each time an internal application of a new type is installed in the multimode terminal MS or an unknown external application is designated, or each time that a transaction request that is to be transmitted is received (in this case, no control information data is stored in the multimode terminal MS and the control software module CM has only to verify the availability of the network interface NIj proposed to it by the network equipment NE).

Instead of this, or in addition to this, at least some of the control information can be transmitted by the network equipment NE at the same time as the control software module CM. In this case, the control information is stored in a memory MY of the multimode terminal MS.

A basic version of the invention may also be envisaged in which the control information is reduced to a table of correspondences in which each type of application is associated with a type of network interface. In this case, the control information may form part of the control software module CM that is downloaded.

The management module MM of the network equipment NE can communicate with each control software module CM installed on a multimode terminal MS, for example using a HyperText Transmission Protocol (HTTP).

Once a control software module CM has selected the network interface NIj suited to the situation (using the control information available to it), it gives preference to sending system commands to the operating system OS in order to check if the routing information stored in the routing table of the routing database RB already contains a route defining a transport (socket) level connection between the selected network interface NIj and the application equipment SE containing the external application EA to which the requested transaction relates. In other words, the control software module CM checks if any of the entries in the routing table consists of an (IP) destination address designating the application equipment SE that contains the external application EA to which the requested transaction relates.

It is important to note that the destination address is not necessarily that of the application equipment SE. It may be an address of a network to which the application equipment SE is connected or of a portion of that network.

If the route is defined in the routing table, then the control software module CM gives preference to checking the availability of the network interface NIj that it has selected. Here the term “availability” refers to the fact that the network interface NIj is usable (enabled). It may happen that a network interface has lost connectivity with the network. To this end, the control software module CM gives preference to sending system commands to the operating system OS, to be more precise to its connection interface API (socket API). System commands such as “IPCONFIG” (in Windows) and “IFCONFIG” (in Linux) enable an internal proxy function (here CM) to determine the availability status of the network interfaces NIj and their identifiers.

If the network interface NIj selected is available, then the control software module CM considers it to be the determined network interface. It then instructs the operating system OS to transmit the transaction request to the designated external application EA via the transport (socket) level connection set up between the determined network interface NIj and the application equipment SE that contains the external application EA.

For example, the control software module CM transmits its instructions to the operating system OS by means of a hypertext transport protocol such as HTTP (HyperText Transmission Protocol) suitable for communication with the external applications EA.

If the selected network interface NIj is not available, then the control software module CM must select another.

If the route to the requested external application EA is not defined in the routing table the control software module CM gives preference to sending system commands to the operating system OS in order for it to create that route and integrate its definition into the routing table of the routing database RB. System commands such as “ROUTE ADD IP@ mask NI-identifier” enable new entries to be incorporated into the routing table. There are also system commands for eliminating entries from the routing table.

Once the route has been incorporated into the routing table the control software module CM gives preference to checking the availability of the network interface NIj that it has selected. If the network interface NIj selected is available, the control software module CM considers it to be the determined network interface. It then instructs the operating system OS to transmit the transaction request to the designated external application EA via the transport (socket) level connection set up between the determined network interface NIj and the application equipment SE that contains the external application EA. If the network interface is not available, the control software module CM must select another (available) network interface.

The management module MM of the network equipment NE of the invention, where applicable with its information database IB, may take the form of electronic circuits, software (or electronic data processing) modules or a combination of circuits and software.

Three applications are briefly described next by way of nonlimiting example.

The first example relates to selecting radio access network interfaces as a function of the type of transaction to be transmitted and assumes that the multimode terminal MS can access discontinuous coverage wireless networks and UMTS mobile networks. Discontinuous coverage access was designed to offer a very high data bit at low cost for relatively long and non-interactive traffic (and therefore for transactions that are not in real time), such as streaming and background data streams. Moreover, UMTS access is suitable for relatively short interactive transactions.

During a streaming session, both access networks may be used according to the type of transaction to be transmitted. Thus the downloaded control software module CM may decide to transmit via the UMTS network interface RTSP (Real Time Streaming Protocol) messages that in particular contain transactions for selecting a file to be viewed, exchanging parameters, configuring connections or requesting the stopping or rewinding of a video and for transmitting video data streams via the network interface dedicated to discontinuous coverage. The selection made by the control software module CM can also take into account other control information, for example the cost of access to the two radio access networks and/or the weight (in bytes) of the video files to be downloaded.

The second example relates to selecting radio access network interfaces as a function of load balancing information. It is assumed here that a user is browsing the Internet using the browser NI1 installed on his multimode terminal MS and connected to the Internet via a wireless local area network (WLAN) consisting of “hot spots” for which the access networks are almost saturated. To prevent browsing quality from being degraded by the saturation of the hot spots, the downloaded control software module CM may decide to change the network interface and therefore the access network at least temporarily to transmit “HTTP GET” messages coming from the browser NI1.

The third example relates to selecting radio access network interfaces as a function of the internal application type. The downloaded control software module CM of a multimode terminal MS can be configured so that Voice over IP (VOIP) internal applications all use the network interface connected to the UMTS radio access network whereas the Internet browser internal application uses the network interface connected to a wireless local area network (WLAN).

The invention is not limited to the network equipment embodiment described above by way of example only and encompasses all variants that the person skilled in the art might envisage that fall within the scope of the following claims.

There is claimed:

1. A network equipment for a group comprising at least two radio access networks of different types connected to a backbone network to which is coupled at least one application equipment including at least one external application adapted to exchange data with at least one internal application installed on multimode radiocommunication mobile terminals and each further comprising an operating system, at least two network interfaces coupled to said operating system and each having an address and being adapted to be connected to respective radio access networks of said group, which network equipment comprises management means adapted to transmit to a designated multimode mobile terminal via a signaling connection a control software module adapted once installed on said designated terminal to provide a proxy interface function between its internal applications and external applications adapted each time that it receives a transaction request designating an external application from an internal application of said terminal to determine which of said network interfaces of said terminal is suited to said transaction as a function of control information and routing information and then to instruct said operating system to transmit said transaction request to said designated external application via a transport level connection between said determined network interface and the application equipment containing said external application.

2. A network equipment according to claim 1, comprising memory means adapted to store at least some of said control information and wherein said management means are adapted to transmit to said terminals via said signaling connection control information that concerns them stored in said memory means so that their control software module can use said information to determine a network interface to be used to transmit at least one transaction request.

3. A network equipment according to claim 2, wherein said management means are adapted on receiving a request from a control software module of a mobile terminal to transmit control information that concerns it to said control software module via said signaling connection set up with its mobile terminal.

4. A network equipment according to claim 2, wherein said management means are adapted on receiving instructions from a radio access network designating at least one mobile terminal to transmit control information that concerns it to the control software module of that designated terminal via said signaling connection.

5. A network equipment according to claim 1, wherein said management means are adapted to initiate the setting up of a signaling connection between its network equipment and a designated terminal.

6. A network equipment according to claim 1, wherein said control information is selected from a group comprising at least data on application types associated with data on network interface types, data on transaction types associated with data on network interface types, data on application types and transaction types associated with data on network interface types, data representing the weight of the data to be transmitted to an internal application and associated with data on network interface types, and network information data associated with data on network interface types.

7. A network equipment according to claim 1, wherein said processing means are adapted to communicate with each software module installed in a mobile terminal using a HyperText Transmission Protocol.
